(19) United States
(12) Patent Application Publication
(10) Pub. No.: US 2012/0324295 A1
(43) Pub. Date: Dec. 20, 2012

(54) METHOD FOR VISUALIZING A PROGRAM EXECUTION

(75) Inventors: Wolfgang Horn, Hohenstein-Ernstthal (DE); Jörg Singer, Chemnitz (DE); Peter Wagner, Hersbruck (DE)

(73) Assignee: Siemens Aktiengesellschaft, Munchen (DE)

(21) Appl. No.: 13/332,997

(22) Filed: Dec. 21, 2011

(30) Foreign Application Priority Data
Dec. 23, 2010 (EP) EP10196710

(51) Int. Cl. G06F 11/36

(52) U.S. Cl. 714/46; 714/E11.208

(57) ABSTRACT

A method for visualizing execution of a program includes the steps of representing the program graphically as a flow diagram, and applying a marking to elements of the flow diagram as a function of state data of a state of the program that is being executed or has been executed.

### CROSS-REFERENCES TO RELATED APPLICATIONS

This application claims the priority of European Patent Application, Serial No. EP10196710, filed Dec. 23, 2010, pursuant to 35 U.S.C. 119(a)-(d), the content of which is incorporated herein by reference in its entirety as if fully set forth herein.

### BACKGROUND OF THE INVENTION

The present invention relates to a visualization of a program execution, in particular of a program in the automation technology field. The detection of the program execution can be represented graphically. The program is in particular a cyclically executable program of an automation device.

The following discussion of related art is provided to assist the reader in understanding the advantages of the invention, and is not to be construed as an admission that this related art is prior art to this invention.

Examples of automation devices are: programmable logic controllers (PLCs), motion controllers (in particular for closed- and/or open-loop control of motion sequences), inverters, process control computers (e.g. for printing presses), e.g. for assembly lines, steel works, machine tools, packaging machines, glass forming machines, etc. Programs are able to execute on equipment of said kind and are programmed by means of an engineering system, for example. Application programs of a machine tool are then used for example on a runtime system of the machine tool.

It is important for a user of the automation system, e.g. an operator or programmer, to be able to detect the execution of the program. A debugger can be used for this purpose. A disadvantageous aspect in this case is for example that the program execution is halted by checkpoints, or that only stored alphanumeric program values are available to the user for analysis. In the case of an ST program (program written in structured text) it is for example possible for a user to activate a DEBUG mechanism. The ST source is displayed to the user in a first visualization window and in the case of a program code that is executed cyclically the values of the variables used in the program code for the respective pass can be displayed consistently in a further window. In the case of cyclical PLC functionality this enables the user to implement diagnostics and program debug in textual form. Although programming based on graphical objects is possible in addition to ST programming, a debug function is based on textual representations.

It would therefore be desirable and advantageous to obviate prior art shortcomings and to provide an improved visualization of a program execution which can be more easily analyzed by a user.

### SUMMARY OF THE INVENTION

The automation system has in particular a device for parameterizing, configuring and commissioning control systems and/or for producing preferably cyclical control programs by means of an editor device for editing a control program and in particular a compiler device for compiling the control program. An engineering system can be used for this purpose. For temporal control of a system based on a control program the automation system can have a microprocessor device for processing a compiled, preferably cyclical control program.

In programmable logic controllers the engineering system is in many cases used for debugging, parameterizing and commissioning a control system, as well as for generating suitable control programs. The runtime system is used for example to record the data of the engineering system and process the control programs accordingly. In this case the runtime system can be communicatively connected to the engineering system also during the operation of the automation device. This means that data can be displayed, processed and/or stored in the engineering system during the execution of the program. For storage purposes the runtime system and/or engineering system can have a trace. The engineering system can be installed on the same hardware as the runtime system or alternatively on hardware separate therefrom.

In particular in the case of cyclically executing control programs the monitoring of variables, program states and command processing operations can advantageously be accomplished by means of a graphical representation. In this context said graphical representation is based in particular on a flow diagram. The user can track the program execution on a monitor and see e.g. how a PLC cycle executes. This enables system parameters to be monitored in a convenient manner during the control program execution. Considered in general terms, the flow diagram is also a representation of a graphical programming interface which is not based solely on ASCII code, but is also supported graphically.

According to one aspect of the present invention, a method for visualizing execution of a program includes the steps of representing the program graphically as a flow diagram, and applying a marking to elements of the flow diagram as a function of state data of a state of the program that is being executed or has been executed.

The state information may be supplied by the runtime system. The program is, for example, a control program of a machine tool, a parts program of a machine tool, a control program of a production machine, a control program of a packaging machine, a control program of a printing press, etc.

The flow diagram is a program sequence chart (PAP) which can also be referred as a flowchart or program structure diagram. An implementation of an algorithm in a computer program can be effected with the aid of a graphical representation. Computer programs in the wider sense are in this case programs which execute on processors for example on control devices (e.g. programmable logic controllers (PLCs)) or closed-loop control devices (e.g. motion controllers) in industrial installations. The graphical representation enables a sequence of operations for solving a problem to be described in a pictorial manner.

Possible symbols for elements in program sequence charts or flowcharts are described for example in DIN 66001. Symbols for data flowcharts as a further type of flow diagram are also defined there. Program sequence charts can also be used independently of computer programs for representing processes and activities. Another example of a flow diagram is a Nassi-Shneiderman diagram (structogram). Extended flow diagrams are also used in the mapping of object-oriented program concepts by means of UML. Symbols and conventions for flow diagrams such as program and system flowcharts are described in the ISO 5807 information processing standard.

Programs represented as flow diagrams have been written for example with the aid of a graphical programming interface, i.e. they are already present in the guise of a flow diagram. It is also possible for programs to be created textually in order to be represented subsequently in graphical form in a flow diagram. A program written in KOP (ladder diagram/continuous function chart) or FUP (function block diagram (FBD)) can also be described in a flow diagram. Programs of said type are translated into machine language, wherein it is provided that data is generated on the machine during the execution of the program and said data can be assigned to an element of the flow diagram. If there are then changes for example to state variables during the program execution, or if subroutines are invoked or processed, an assignment to one of the elements of the flow diagram can be carried out. Said assignment takes place for example online, in particular in real time, or at a subsequent stage, in particular through the use of a trace. Data associated with elements in the flow diagram is stored in the trace for the purpose of evaluating said elements following processing of a program. The elements of the flow diagram can be marked as a function of state data of the executing or executed program. State data indicates in particular which point in the program is currently being processed or has just been processed. The processing steps can also result in changes to state values (e.g. variables, truth values, or the like) which can also be visualized.

Elements can be described by means of ovals, rectangles, diamonds, etc. According to DIN 66001, start points, stop points or limit points are described by means of an oval for example. Arrows and lines indicate a connection to the next-sequential element. A rectangle represents an operation, while a rectangle having double-struck vertical lines indicates a call of a subroutine. A branching point is described by means of a diamond, a truth check being symbolized thereby. Inputs and outputs can be represented for example as a parallelogram. As well as start elements, stop elements, limit point elements, operation elements, elements for invoking or processing one or more subroutines, branching elements, input elements or output elements, further elements still can also be implemented in a flow diagram.

According to an advantageous feature of the present invention, the program may be a cyclical program. Specifically in the case of cyclical programs it is difficult to represent the state of the program at a given moment in time. This is due in particular to the fact that the clock rates of the processors are very high and there are cyclical program sequences through which multiple passes are completed in one second. In this situation analysis with the aid of a trace (information store) can help for example.

According to an advantageous feature of the present invention, the program may have a plurality of branching points, i.e. at least two branching points. If multiple passes through a branching point are made in a cyclical program execution, i.e. passes performed repeatedly for a relatively long time (e.g. more than one second), then even with high clock rates an online representation of states of elements of the flow diagram can lead to an assessment concerning the processing of the program. If, for example, elements just processed during the program execution are marked in color and if at the same time a particular branch is always selected after a branching point (element), then it can be seen by an observer online and in real time which branches of the program are being processed or, as the case may be, are not being processed. This is also possible when a cyclical program is processed e.g. one hundred times per second. If the processing of different branches changes only so often that it is possible for this to be resolved by a human eye (e.g. in a tenth of a second, or even minutes), then an observer can also see, online on the flow diagram whose elements are linked for data processing purposes to the executing program, in which processing step the program currently finds itself and in particular also which processing branch is currently being used.

The state data according to which at least some elements of the flow diagram change their graphical appearance may not only be acquired online from an executing program, but also at a subsequent stage from trace data. Data from the executing program is stored by means of the trace.

According to an advantageous feature of the present invention, the graphical appearance may be modified, for example, by means of one or more of the following measures:

a change in the color of an element;

a change in the line weight of an element;

a change in the grayscale value of an element;

a change in the labeling of an element;

a change in the color saturation of an element;

by flashing an element, etc.

According to an advantageous feature of the present invention, the marking may be displayed for a longer time than the state causing the marking persists. Advantageously, the duration of this longer display may also be set and varied by a user so that for example a state change will be visualized for 1 second, 2 seconds, 3 seconds, etc. longer than said state change is present. In this way even momentary changes can be visualized more effectively for a human being.

According to an advantageous feature of the present invention, the state data which may also change may be recalculated multiple times in the course of a second.

According to an advantageous feature of the present invention, the program which is represented graphically may be, for example, a parts program of a machine tool. Specifically in the case of machine tools there are branching points in cyclical program runs where it is important for an operator of the machine tool to find out in which branch of the program processing the machine tool is currently located. In this case the program processing branch is dependent e.g. on which workpiece is currently being machined. As a result of the graphical representation in real time the operator of the machine tool can tell whether the right program branch is being processed.

The method described can be used quite generally also for a program that is designed to control a motion sequence. This relates for example to pick-and-place machines, flow wrapper machines, cranes, etc.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a flow diagram for visualizing the execution of a program according to the present invention.

### DETAILED DESCRIPTION OF PREFERRED EMBODIMENTS

These depicted embodiments are to be understood as illustrative of the invention and not as limiting in any way. Some details which are not necessary for an understanding of the present invention or which render other details difficult to perceive may have been omitted.

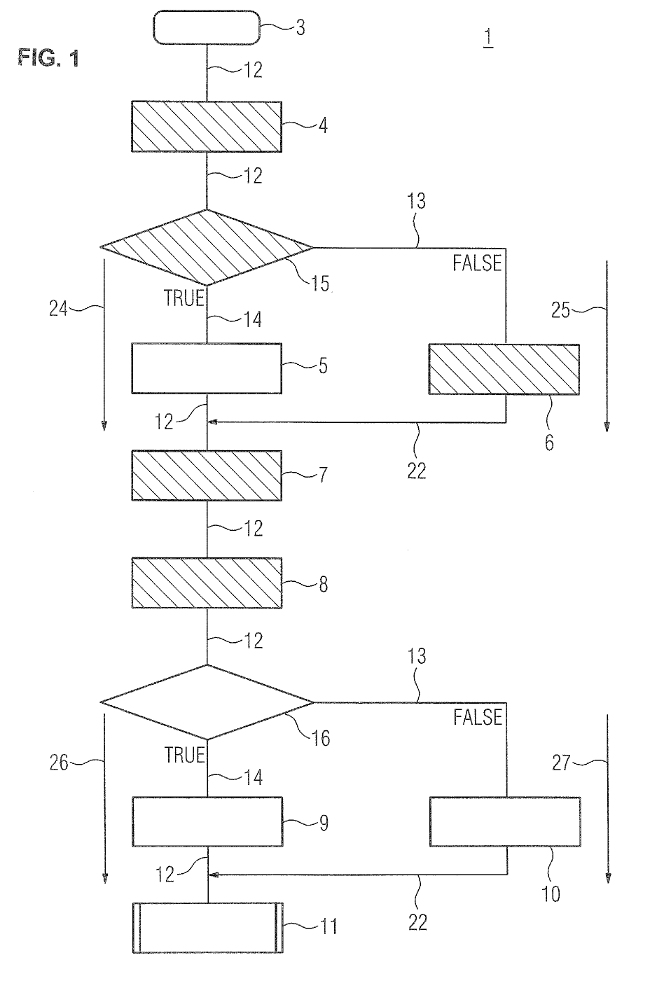

Turning now to the drawing, in which FIG. 1 is the sole FIGURE, there is shown a flow diagram 1. An oval 3 indicates a start point of the program depicted. A connection to a following element 4 is established via a line 12. Said element 4 is a rectangle and indicates an operation. The element 4 represents for example a resetting of an output. The element 4 is linked via the connection 12 to the element 15. The element 15 is a diamond and symbolizes a branching point. If a condition is true, then the element 5 is processed next via the true connection (TRUE) 14. If a condition of the element 15 is recognized as “false” (FALSE), then the element 6 is processed via the false connection 13. Accordingly two processing branches are produced by means of the branching element 15. A first processing branch 24 has the element 5 and a second processing branch 26 has the element 6. Only one of the two branches 25, 26 can be passed through at any given time. Outputs, for example, can be set by means of the elements 5 and 6. The element 5 of the first branch 24 sets an output A1 for example to the value x and the element 6 of the second branch 25 sets the output A1 for example to the value y. The two branches 24, 25 are merged once more ahead of the element 7 by way of an arrow connection 22 and a line. The element 7 relates to an axis enabling circuit. The element 8 for input of command code follows on from the element 7. Following a further interrogation of a condition in the element 16 another branching point is produced, the second branching point of the FIGURE. A first branch 26 of said second branching point has the element 9 and the second branch 27 of said second branching point has the element 10. If the condition of the element 16 is recognized as true (TRUE), then the element 9, which is e.g. a variable assignment, is processed. If the condition of the element 16 is recognized as false (FALSE), then the element 10, which is also e.g. a variable assignment, is processed. The two branches 26 and 27 end in an element 11, which represents a call to a subroutine. From the representation in the FIGURE it is clear that the elements 4, 15, 6, 7 and 8 are marked. The path 25 is therefore passed through at least once or even cyclically.

According to a method for visualizing a program execution there is provided, in an engineering system or a diagnostic system for example, a functionality by means of which the user monitors in particular sequentially processed programs graphically with the aid of a flow diagram. Processed commands can be color-coded in the visualized flow diagram. If specific branching paths are passed through repeatedly in succession, there results a kind of track from which selected branching points can be read off. In cyclically processed programs it may happen under certain conditions that the color-coded elements that are visible to a user do not correspond to the actual program execution since the cyclical processing is performed extremely quickly and consequently can only be represented to a limited degree. If, however, a certain delay in resetting the color coding is provided (this can also be adjustable: e.g. 0.5 sec, or 3 sec), then a color coding can also be seen by a user even when the state has long since changed. A user therefore recognizes when e.g. an element in a flow diagram has been processed even just for a fraction of a second.

According to the method described it is possible in the case of a graphical program that is processed cyclically for the user to receive information about how the program execution is proceeding. By means of the visualized information the user in this case receives pointers e.g. indicating where it makes sense to introduce further functionalities such as e.g. a status program.

In an embodiment it is also possible to load a reduced amount of information about the graphical program execution in addition into a runtime system and to record the execution of the graphical command sequence in the runtime system in real time in a storage medium (trace). This information is returned to the engineering system for visualization. In the graphic the engineering system color-codes the graphical command blocks processed by a CPU, which are elements of the flow diagram, as appropriate. Even in the case of rapidly processed programs the user can therefore track how the actual program execution is progressing. By means of a selection of program elements a user can personally decide which elements of a flow diagram he or she wishes to monitor. In this way complex process flows can be reduced to a small number of displayed and monitored elements.

In an embodiment of the method elements that have been marked once remain marked. This results in a kind of light trail which reveals the processing and the branching points. The marking can be reset by means of a user action, for example by canceling a color-coded marker.

By means of the described method for visualizing a program execution it is possible to track a cyclical processing of graphical programs directly in a graphical program representation. A kind of light trail or trace can be embodied by means of graphical color coding of the program steps or program blocks that have been passed through. The light trail is produced for example by means of color intensification corresponding to the frequency of passes made in the cyclical execution. A specific identification marking of single passes can also be provided.

By recording the program processing sequence in the runtime system and the subsequent transfer of the information to the engineering system it is possible to visualize the overall program execution even in the case of fast processing of the graphical elements/command blocks by recording in real time even in the case of cyclical program processing. As a result of the color coding the program execution can then be satisfactorily visualized in graphical programs.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for visualizing execution of a program, comprising the steps of:
representing the program graphically as a flow diagram, and applying a marking to elements of the flow diagram as a function of state data of a state of the program that is being executed or has been executed.

2. The method of claim 1, wherein the program is a cyclical program.

3. The method of claim 1, wherein the program has a plurality of branching points.

4. The method of claim 1, wherein the state data are trace data.

5. The method of claim 1, wherein the marking for a state of the program is displayed for a longer time than a time during which the state of the program persists.

6. The method of claim 1, wherein the program is a parts program of a machine tool.

7. The method of claim 1, wherein the program is a program for controlling a motion sequence.

8. The method of claim 1, wherein the state data of the program are recalculated multiple times in the course of a second.

9. The method of claim 1, wherein the program has at least one of the following elements: a start element, a stop element, a limit point element, an operation element, a subroutine element, a branching point element, an input element and an output element.

10. The method of claim 1, wherein a section of the flow diagram is selected, and wherein elements in the selected section of the flow diagram are represented differently depending on the state data.
